(19) United States
(12) Patent Application Publication
(10) Pub. No.: US 2008/0027691 A1
(43) Pub. Date: Jan. 31, 2008

(54) Device manufacturing support apparatus, simulation method for device manufacturing support apparatus, and device manufacturing apparatus

(75) Inventors: Hiroki Kobayashi, Kawasaki (JP); Yuichi Sato, Kawasaki (JP); Masayoshi Hashima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/607,995

(22) Filed: Dec. 4, 2006

(30) Foreign Application Priority Data
Jul. 31, 2006 (JP) 2006-208201

(51) Int. Cl. G06G 7/48

(52) U.S. Cl. 703/6

(57) ABSTRACT

In a device manufacturing support apparatus, shape models having variations are generated by a process simulator simulating a manufacturing process, and a result thereof is input to a device simulator. Then, characteristic variations of a device are evaluated, an optimal value and an acceptable range of a parameter are estimated, and simulation is performed again by using the parameter. This process is repeated so as to determine the optimal value and acceptable range of the parameter.

### BACKGROUND OF THE INVENTION

1. Field of the Invention

The present invention relates to a simulation technique used in relation to manufacturing of micro/nano devices, such as semiconductor devices, MEMS devices, HDD heads, and electronic devices.

2. Description of the Related Art

At manufacturing of devices including semiconductor devices, various manufacturing parameters need to be adjusted in order to enhance element performance, to reduce manufacturing variations, and to increase yield. In a conventionally-used method, wafers are actually manufactured under various manufacturing parameters and are evaluated, and then wafers are experimentally manufactured while the manufacturing parameters are repeatedly adjusted. In this method, the cost and the length of the experimental period are problems to be solved. For example, in manufacturing of high-novelty devices, several tens or more of experiments may be required to determine manufacturing parameters. Thus, reducing the number of experiments is urgent necessity.

The present invention is directed to providing a device manufacturing support apparatus to determine optimal parameters to manufacture devices by simulating a manufacturing process.

### SUMMARY OF THE INVENTION

A device manufacturing support apparatus according to an embodiment of the present invention includes a setting unit configured to set a parameter to a simulator; a process simulator configured to simulate a manufacturing process of a device by using the set parameter; a device simulator configured to simulate a characteristic of the device by using a simulation result of the manufacturing process; an evaluating unit configured to evaluate a simulation result of the characteristic of the device; and a determining unit configured to determine the parameter on the basis of an evaluation result.

With this configuration, a parameter of the process simulator is determined on the basis of an evaluation result of the process simulator, so that a process parameter can be determined so that an optimal characteristic value can be obtained.

### BRIEF DESCRIPTION OF THE DRAWINGS

FIG. 1 shows a configuration of a device manufacturing support system;

FIG. 2 shows a recipe of processes to make a magnetic head;

FIG. 3 is a flowchart showing a calibration process;

FIGS. 4A and 4B illustrate deposition;

FIG. 5 illustrates a film thickness;

FIG. 6 illustrates a bias film deposition simulator;

FIG. 7 is a flowchart showing a process of determining an optimal value; and

FIG. 8 illustrates convergence of a parameter.

### DESCRIPTION OF THE PREFERRED EMBODIMENT

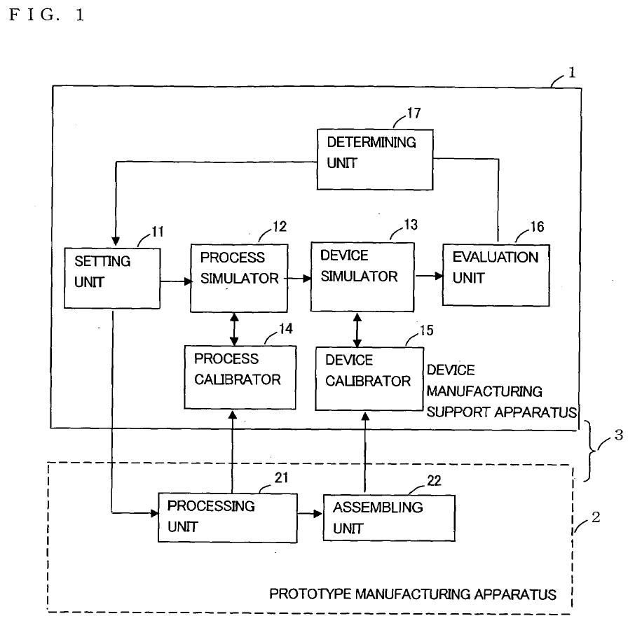

FIG. 1 shows a configuration of a device manufacturing support system 3.

The device manufacturing support system 3 includes a prototype manufacturing apparatus 2 and a device manufacturing support apparatus 1.

The prototype manufacturing apparatus 2 manufactures prototypes of a magnetic head and includes a processing unit 21 and an assembling unit 22.

The device manufacturing support apparatus 1 includes a setting unit 11, a process simulator 12, a device simulator 13, a process calibrator 14, a device calibrator 15, an evaluating unit 16, and a determining unit 17.

The processing unit 21 of the prototype manufacturing apparatus 2 performs deposition and ion milling on a supplied wafer so as to form a wafer provided with a plurality of sliders.

In a CPP-type reproducing head formed on a wafer, a magnetoresistance element is placed between a lower electrode layer and an upper electrode layer. Also, a magnetic-domain control layer sandwiching the magnetoresistance element from its side surfaces is provided between the lower electrode layer and the upper electrode layer. Both the lower and upper electrode layers are made of soft magnetic material such as NiFe and function as a magnetic shield layer.

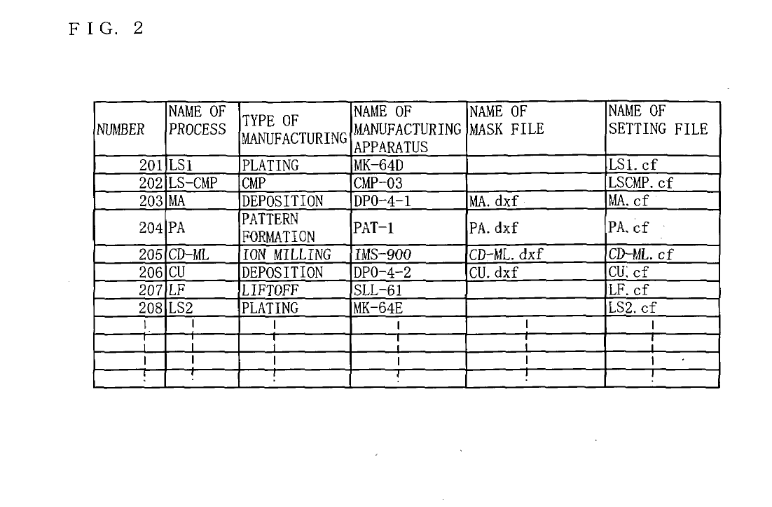

FIG. 2 shows a recipe of processes to manufacture a magnetic head.

The recipe shows numbers, names of processes, types of manufacturing, names of manufacturing apparatuses, names of mask files to be used, and names of setting files to store various parameters. The manufacturing is performed in accordance with the numbers.

A method for manufacturing a reproducing head is described below. A reproducing head is formed on a wafer made of AlTic.

First, a lower electrode layer is formed by plating with NiFe. This is the process of No. 201 in the recipe.

After the plating, the surface of the lower electrode layer is smoothed by CMP (chemical mechanical polishing). This is the process of No. 202 in the recipe.

Then, a magnetoresistance film is deposited on the surface of the lower electrode layer. This is the process of No. 203 in the recipe.

Then, a photosensitive resist is adhered, and a T-shaped liftoff pattern is formed by exposure and development in order to etch the magnetoresistance film and to form a magnetoresistance element. This is the process of No. 204 in the recipe.

Then, the magnetoresistance film is etched by ion milling by using the liftoff pattern as a mask. Accordingly, a side surface of the magnetoresistance element is etched to an inclined surface. This is the process of No. 205 in the recipe.

Then, under a state where the liftoff pattern is formed on the magnetoresistance element, a bias layer is deposited. This is the process of No. 206 in the recipe.

Then, liftoff is performed. This is the process of No. 207 in the recipe.

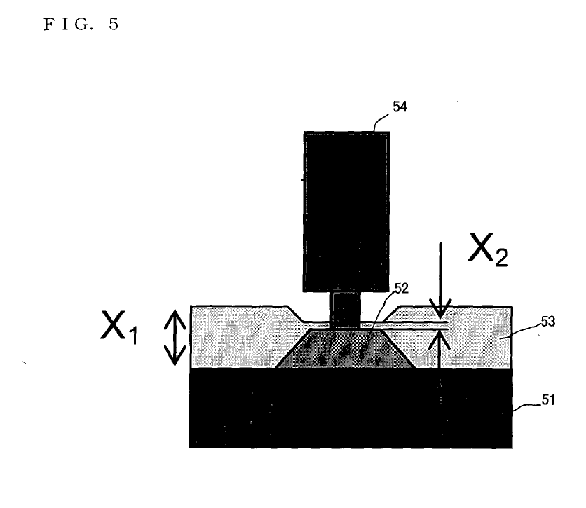

Then, an upper electrode layer is plated on the surface of the magnetoresistance element. This is the process of No. 208 in the recipe. Accordingly, the reproducing head is completed. FIG. 5 shows the completed reproducing head.

Then, a recording head is formed on the upper layer of the reproducing head, so that a magnetic head is obtained.

The assembling unit 22 of the prototype manufacturing apparatus 2 shown in FIG. 1 assembles individual slider products from a formed wafer through wrapping and measurement of a characteristic.

For example, the assembling unit 22 cuts a wafer in one direction, a plurality of sliders being mounted on the wafer, forms a block called rowbar in which slider portions are aligned, performs a function test on this bar, and cuts the bar into sliders. By performing a process such as polishing on a surface of the bar facing a medium, the heights of a magnetoresistive layer of a magnetic head thin film and a gap become uniform. Then, characteristics including a magnetic characteristic, an electrical characteristic, and a physical characteristic are measured, and a wafer satisfying the characteristics is shipped as a slider.

The setting unit 11 of the device manufacturing support apparatus 1 shown in FIG. 1 sets data for simulation and manufacturing to the process simulator 12, the device simulator 13, and the prototype manufacturing apparatus 2. The data includes mask data, manufacturing data, environment data, and parameters. Thus, the setting unit 11 includes a memory to store the data and the recipe.

The process simulator 12 simulates each process of a magnetic head. Simulators to simulate respective processes, such as a deposition simulator, a plating simulator, a CMP (chemical mechanical polishing) simulator, and an ion milling simulator, are used.

The device simulator 13 simulates characteristics of a magnetic head, such as a magnetic characteristic and an electrical characteristic.

The process calibrator 14 obtains data output from the processing unit 21 and stores the data in a memory. Then, the process calibrator 14 sets parameters of the process simulator 12 so that the set parameters match with the data output from the processing unit 21.

The device calibrator 15 obtains a measurement result of various characteristics of a magnetic head, such as a magnetic characteristic and an electrical characteristic, obtained from the assembling unit 22, and stores the measurement result in a memory. Then, the device calibrator 15 sets parameters so that the set parameters match with the data output from the assembling unit 22.

The evaluating unit 16 performs process simulation and device simulation on the basis of the parameters at the time when calibration ends, so as to determine whether an optimal characteristic value has been obtained.

The determining unit 17 determines to change the parameters if the optimal characteristic value cannot be obtained and to repeat simulation. If the optimal characteristic value has been obtained, simulation ends.

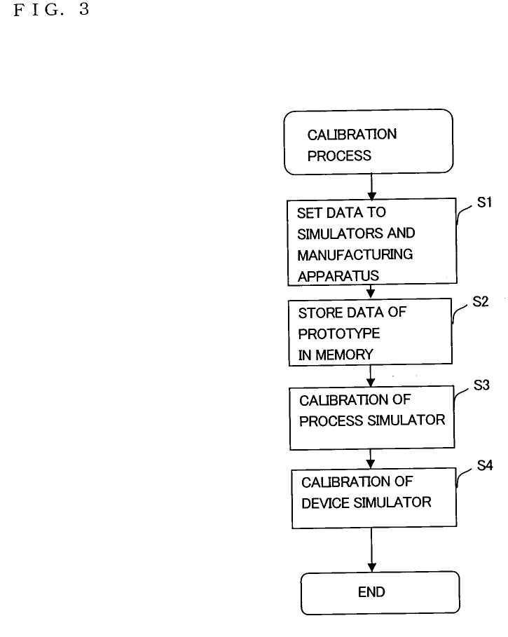

FIG. 3 is a flowchart showing a calibration process.

First, a mask file and a setting file are obtained from the recipe and various data is set to the prototype manufacturing apparatus 2, the process simulator 12, and the device simulator 13 (step S1).

Then, the prototype manufacturing apparatus 2 manufactures a prototype, and shape data and characteristic data of the device in the respective processes are obtained. The obtained data is stored in the memory of the process calibrator 14 (step S2).

Then, data of a test result of a characteristic value of the device in the assembling process is obtained. The obtained data of the test result is stored in the memory of the device calibrator 15.

The process calibrator 14 calibrates the process simulator 12 on the basis of the data obtained from the processing unit 21 (step S3). Then, the device calibrator 15 calibrates the device simulator 13 on the basis of the data obtained from the assembling unit 22 (step S4). The parameters of the simulators are determined by the calibration.

For example, a case where a bias film is deposited in an experimental process is described.

In this process, the mask file Cu.dxf and the setting file Cu.cf of No. 209 in the recipe are obtained. Then, data of the obtained files is set to a manufacturing apparatus DP0-4-3 of the processing unit 21.

The mask file Cu.dxf includes data of a formation range of a bias film.

The setting file Cu.cf includes manufacturing data, such as material data, an environmental condition, an internal gas condition, and an ionization rate.

Next, an example where the prototype manufacturing apparatus 2 forms a bias film on a magnetoresistance element by spattering is described below. The operation performed by the processing unit 21 is as follows.

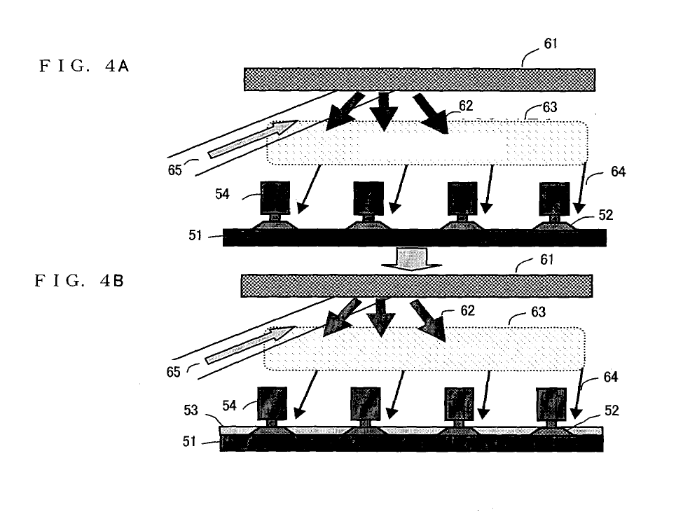

FIGS. 4A and 4B illustrates deposition.

The prototype manufacturing apparatus 2 applies a laser beam 65 onto a sample plate A61. The collision of the laser beam 65 with the sample plate A61 causes ejection of particles 62 of ion A from the sample plate A61. Then, the ejected particles 62 of ion A come into collision with a gas 63 of ion B of an internal gas. The collision between the particles 62 of ion A and the gas 63 of ion B causes ejection of particles 64 of ion B. As a result, the particles 64 of ion B adhere to magnetoresistance elements 52 on a lower electrode 51 (see FIG. 4A). Then, particles 64 of ion B are accumulated, so that a predetermined thickness of the bias film 53 is formed (see FIG. 4B).

FIG. 5 illustrates a film thickness.

In this figure, the magnetoresistance element 52 is formed on the lower electrode 51, and the bias film 53 and a resist 54 are formed thereon.

Thicknesses X1 and X2 of the deposited bias film 53 are obtained by measuring shape data N. X1 is a value depending on an adhesion rate and X2 is a value depending on an ion divergence angle. Data of these measurement results is stored in the process calibrator 14.

Then, the process simulator 12 simulates deposition of a bias film.

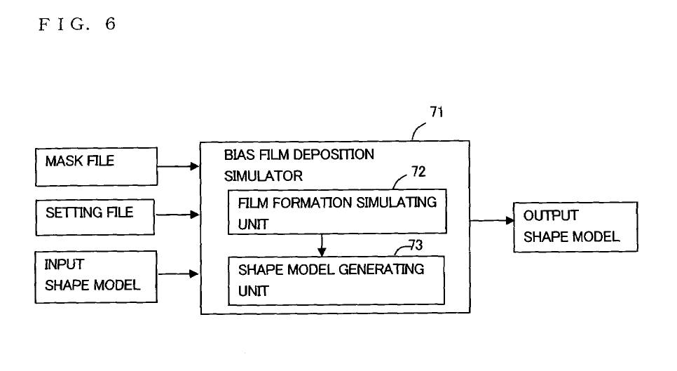

FIG. 6 illustrates a bias film deposition simulator.

The bias film deposition simulator 71 includes a film formation simulating unit 72 and a shape model generating unit 73.

A mask file, a setting file, and an input shape model are input thereto, and an output shape model is output therefrom.

The mask file Cu.dxf includes data of a formation range of a bias film.

The setting file Cu.cf includes simulation data, such as parameters of an ionization rate, an ion divergence angle, and an adhesion rate.

The input shape model is an output shape model N−1 of a previous process of the bias film. The shape model N−1 is a shape in which the T-shaped resist 54 is formed on the magnetoresistance element 52 on the lower electrode 51 that is formed in the previous process.

The film formation simulating unit 72 performs simulation by calculating, with a predetermined formula, an exercise behavior of respective ion particles shown in FIG. 4, such as collision, ejection, and adhesion.

The shape model generating unit 73 calculates a shape on the basis of the input shape model and the simulation of motion of ion of the film formation simulating unit 72, so as to form an output shape model. At this time, SX1 corresponding to the value of X1 shown in FIG. 5 and SX2 corresponding to X2 are also output.

Then, the process calibrator 14 calibrates deposition of the bias film.

As a result of simulation performed by the deposition simulator 71, a value of SX1 corresponding to X1 that has been measured by the processing unit 21 is obtained.

Then, SX1 is compared with X1. If the both values differ from each other, simulation is performed by sequentially changing the adhesion rate until SX1 becomes equal to X1 of a prototype result, because SX1 depends on the adhesion rate. Accordingly, a necessary adhesion rate A can be obtained.

Then, the obtained adhesion rate A is fixed, and the simulation is continued while the ion divergence angle is adjusted so that X2 as a prototype measurement result matches with SX2 as a simulation result. Accordingly, a necessary ion divergence angle B can be obtained.

As a result, undetermined parameters on the simulator, that is, the adhesion rate and the ion divergence angle, can be determined. Then, data of shape model N at the time when the adhesion rate and the ion divergence angle are fixed is obtained, and the data is stored in the setting file of the setting unit 11 together with the characteristic parameters of the adhesion rate and the ion divergence angle.

On the other hand, a plurality of prototypes are manufactured when the undetermined parameters SX1 and SX2 are obtained. At this time, the plurality of prototypes are manufactured while varying the ionization rate and so on, so that manufacturing variations occur due to an environmental condition and variation of components.

Then, an average of actual measured values of X1 is calculated, and values within a predetermined standard deviation are calculated on the basis of the average. Those values are X11 to X1N. Then, among actual measured values of X2, values corresponding to the selected X1 to X1N are extracted. For example, X21 to X2N. Then, adhesion rates A1 to AN, ion divergence angles B1 to BN, and shape data N1 to NN corresponding to the selected X1 to X1N and X21 to X2N are obtained. The adhesion rates and ion divergence angles (A1, B1) to (AN, BN) are variations of parameters. At this time, values of ionization rate corresponding to the adhesion rates and ion divergence angles are also stored in the setting file. Accordingly, variation of the ionization rate can be obtained.

On the other hand, in part of a process, instead of calculating collision, dispersion, and adhesion of ion particles in the above-described deposition by using simulation of a physical law causing exercise behavior of respective particles, model generation of three-dimensional simulation by graphical operation can be used. For example, this method is used when it is difficult to perform simulation of a physical behavior, such as a smoothing process, but a relationship between a processing result and an input shape model can be estimated on the basis of a prototype.

For example, a film thickness and a range of film formation are actually measured after the lower electrode has been smoothed. Then, graphical operation to regenerate a shape model of the lower electrode in accordance with the measured range of film formation and film thickness is performed for calibration. When the lower electrode is a rectangular parallelepiped, a graphical operation may be performed so that the shape model of the lower electrode on a substrate model is replaced by a shape of the rectangular parallelepiped based on the measured range of film formation and film thickness.

Then calibration of the device simulator 13 is performed.

For this purpose, characteristic values including a magnetic characteristic in a test process in an assembling process in an experimenting process are measured.

For example, in a magnetic characteristic, it is determined whether a relationship between an applied magnetic field and a change rate of magnetoresistance has a predetermined output characteristic.

Then, the device calibrator 15 performs calibration of the device simulator 13 in accordance with the measurement result.

Input data of the device simulator 13 includes a shape model, physical property data, and parameters. The device simulator 13 obtains behavior of an entire magnetic body by obtaining magnetization distribution by dividing the magnetic body into micro magnetic bodies on the basis of micro-magnetics. As a shape model, output from the process simulator 12 or a measurement result of a prototype is used. The physical property data is obtained from a material physical property list or the like. Parameters include, for example, an undetermined parameter such as a dumping constant of magnetization spin.

Then, matching of undetermined parameters is performed so that a simulation result becomes the same as an actual measured value. Then, a plurality of prototypes are manufactured and a plurality of actual measured values of a characteristic of a reproducing head are obtained. Then, parameters are determined in accordance with data within standard deviation of the actual measured values.

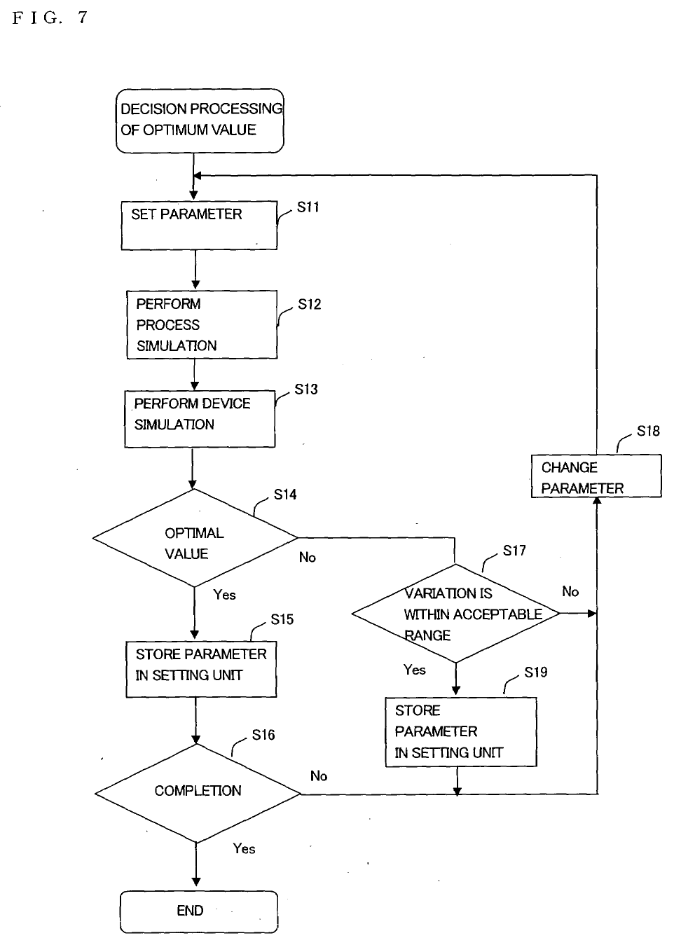

FIG. 7 is a flowchart showing a process of determining an optimal value.

After calibration of the process simulator 12 and the device simulator 13 has finished, simulation to obtain an optimal value of a parameter is performed. Each simulator can come into correspondence with a prototype magnetic head due to calibration, but the prototype magnetic head does not always have an optimal characteristic as a magnetic head. Therefore, simulation is performed to obtain an optimal characteristic of a magnetic head.

The simulation is performed by only the process simulator 14 and the device simulator 15 without performing feedback from the prototype manufacturing apparatus 2.

That is, a parameter obtained through calibration is set (step S11) and then process simulation is performed in accordance with the process (step S12). At this time, simulation of a three-dimensional shape is performed by using a shape model.

Then, device simulation such as analysis of a magnetic characteristic is performed (step S13).

Then, whether a simulation result is an optimal value is evaluated (step S14).

If the optimal value has been obtained, the parameter is stored in the setting unit 11 (step S15).

Then, whether all processes have been completed is checked (step S16).

If all processes have been completed, the process ends. Otherwise, the parameter is changed (step S18) and the process returns to step S11.

If the optimal value has not been obtained, it is determined whether the variation is within an acceptable range (step S17).

If the variation is outside the acceptable range, the parameter is changed (step S18) and the process returns to step S11.

If the variation is within the acceptable range, the parameter is stored in the setting unit 11 (step S19), the parameter is changed (step S18), and the process returns to step S11.

The process completes after the optimal value and a parameter of a variation value of the acceptable range have been determined.

The parameter is a multivariable parameter. Thus, a target parameter is changed and process simulation and device simulation are performed again so as to obtain a parameter to realize an optimal device simulation result. The parameter is changed within the range of variation of the parameter obtained by calibration. In order to change a plurality of parameters, an optimizing method such as sensitivity analysis is used. For example, sensitivity analysis means determining how much a simulation result changes when a parameter changes. If result data significantly changes with a slight change of a parameter, the sensitivity is high. Otherwise, the sensitivity is low. High sensitivity causes a significant effect, so that the parameter is converged as a target parameter.

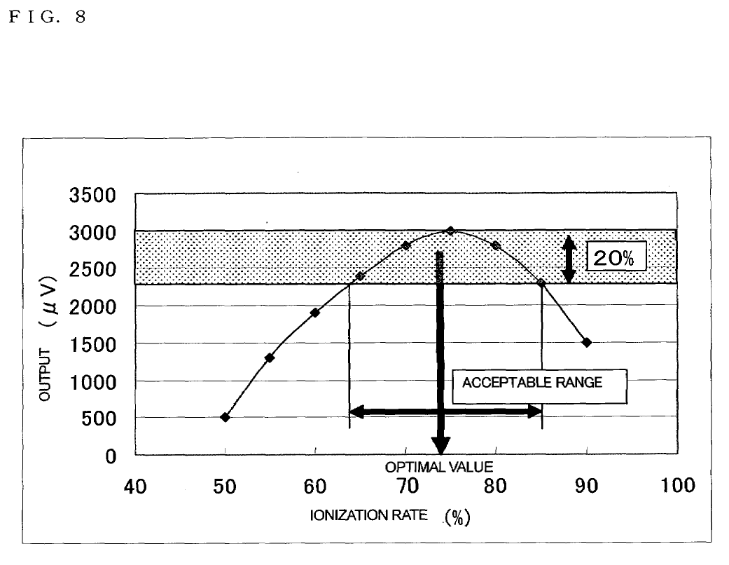

FIG. 8 illustrates convergence of a parameter.

Regarding optimization of a parameter, an example of the above-described deposition of a bias film is described.

The ionization rate of the gas 63 of ion B is one of parameters of deposition, and is a target parameter having an effect on a magnetic characteristic. As data of ionization rate, ion divergence angle, and adhesion rate, data having variation as a result of calibration is used.

In process simulation, deposition of bias films having different ionization rates is simulated.

After the simulation of deposition of bias films has been completed, process simulation of the other processes is performed by using the simulation result as a model, so as to generate wafer models corresponding to the ionization rates. By using the wafer models, a magnetic characteristic of a magnetic head is analyzed, and an output characteristic, including magnitude of output and symmetrical property with respect to positive/negative of a magnetic field of a magnetic medium, is analyzed. Accordingly, the relationship between an ionization rate and an output characteristic can be estimated.

That is, an ionization rate with which an optimal characteristic can be obtained is determined on the basis of the relationship between an ionization rate and an output characteristic. Then, the determined ionization rate is set and process simulation and device simulation for analyzing a magnetic characteristic are performed. This is repeated until the output characteristic converges to an optimal value. After the convergence, a parameter of the optimal ionization rate can be obtained. Also, an acceptable range of the ionization rate is obtained during this process.

For example, as shown in FIG. 8, assume that the ionization rate according to a calibration result of deposition of a bias film is 60% to 90%. Also, assume that an optimal value to be obtained is 3000 μV and that an acceptable range is 2400 μV of 20%.

In this case, a device simulation result is obtained by varying the ionization rate by 5% increments from 60%. As a result, values of 1800 μV and 2450 μV can be obtained at 60% and 65%, respectively. Thus, it can be estimated that an optimal output can be obtained by increasing the ionization rate. Accordingly, the ionization rate is further varied to 70%, 75%, 80%, 85%, and 90%, so that output values of 2800 μV, 3000 μV, 2800 μV, 2400 μV, and 1500 μV can be obtained. On the basis of the variation in the output value, it can be estimated that an optimal value is 75% and an acceptable range is 63% to 85%. These ionization rates are stored in the setting file of the setting unit 11.

The other parameters are also determined in the same manner so as to converge the parameters. As a result, optimal parameters and an acceptable range of the parameters are determined. The determined parameters are stored in the setting file of the setting unit 11.

A manufacturing condition is set to the prototype manufacturing apparatus 2 on the basis of the set parameters, prototypes are manufactured, and it is finally determined whether a predetermined characteristic can be obtained in the prototypes.

As described above, appropriate parameters can be obtained by converging parameters. Thus, the device manufacturing apparatus can manufacture magnetic heads by using the appropriate parameters, so that the number of experiments to find optimal parameters to manufacture magnetic heads can be reduced. This is because an experiment to manufacture an actual product need not be repeated until optimal parameters are obtained.

What is claimed is:

1. A device manufacturing support apparatus comprising:
a parameter setting unit configured to set a parameter to a simulator;
a process simulator configured to simulate a manufacturing process of a device by using the set parameter;
a device simulator configured to simulate a characteristic of the device by using a simulation result of the manufacturing process;
an evaluating unit configured to evaluate a simulation result of the characteristic of the device; and
a determining unit configured to determine the parameter on the basis of an evaluation result.

2. The device manufacturing support apparatus according to claim 1, further comprising:
a calibrator configured to change the parameter of the simulators on the basis of an actual measurement result of the manufacturing process.

3. The device manufacturing support apparatus according to claim 1, wherein the simulators perform simulation by using a three-dimensional shape model of the device.

4. The device manufacturing support apparatus according to claim 1, wherein the process simulator includes converting means for converting an input shape to an output shape by graphical operation.

5. The device manufacturing support apparatus according to claim 1, wherein the evaluating unit determines whether the simulation result of the characteristic of the device matches with a predetermined optimal value.

6. The device manufacturing support apparatus according to claim 1, wherein the evaluating unit determines whether the simulation result of the characteristic of the device is within a predetermined range.

7. The device manufacturing support apparatus according to claim 1, wherein the determining unit changes the parameter if the simulation result of the characteristic of the device does not match with an optimal value.

8. The device manufacturing support apparatus according to claim 1, wherein the determining unit changes the parameter if the simulation result of the characteristic of the device is not within a predetermined range.

9. The device manufacturing support apparatus according to claim 1, wherein the device is a magnetic head.

10. The device manufacturing support apparatus according to claim 9, further comprising:
a calibrator configured to change the parameter of the simulators on the basis of an actual measurement result of the manufacturing process.

11. A simulation method for a device manufacturing support apparatus including a process simulator to simulate a manufacturing process of a device and a device simulator to simulate a characteristic of the device by using a simulation result of the manufacturing process, the simulation method comprising:
a step of setting a parameter to each of the simulators;
a step of simulating a manufacturing process of a device by the process simulator by using the set parameter;
a step of simulating a characteristic of the device by the device simulator by using a simulation result of the manufacturing process;
a step of evaluating a simulation result of the characteristic of the device; and
a step of determining the parameter on the basis of an evaluation result.

12. A device manufacturing apparatus comprising:
a processing unit for forming a device; and
an assembling unit for assembling from formed device, wherein the processing unit uses a manufacturing parameter determined by a device manufacturing support apparatus said device manufacturing support apparatus including
a parameter setting unit configured to set a parameter to a simulator,
a process simulator configured to simulate a manufacturing process of the device by using the set parameter,
a device simulator configured to simulate a characteristic of the device by using a simulation result of the manufacturing process,
an evaluating unit configured to evaluate a simulation result of the characteristic of the device, and
a determining unit configured to determine the manufacturing parameter on the basis of an evaluation result.
